(19) United States
(12) Patent Application Publication
(10) Pub. No.: US 2026/0110333 A1
(43) Pub. Date: Apr. 23, 2026

(54) HUB SEAL

(71) Applicant: NOK CORPORATION, Tokyo (JP)

(72) Inventors: Yuya SAKANO, Fukushima (JP); Kazuki HIROTA, Fukushima (JP)

(21) Appl. No.: 19/111,584

(22) PCT Filed: Sep. 15, 2023
(86) PCT No.: PCT/JP2023/033672

§ 371 Date: Mar. 13, 2025

(30) Foreign Application Priority Data
Sep. 16, 2022 (JP) 2022-148368

(51) Int. Cl. F16C 33/78; B60B 27/00

(52) U.S. Cl. CPC F16C 33/7889; F16C 33/7823; B60B 27/0073; B60B 2900/5112; B60B 2900/5114

(57) ABSTRACT

A hub seal has a side lip and is intended for sealing of a space between an outer ring and a hub of a hub bearing. In the hub seal, a value (torque T/shaft-diameter D) resulting from division of torque T as a value of torque of the hub seal in the hub bearing, which rotates at a rotation speed in a predetermined range, by a shaft diameter D as a value of a diameter of a shaft of the hub bearing is equal to or lower than 3 N, and a value of a muddy-water durable sliding distance is equal to or longer than 3,000 km.

### CROSS REFERENCE TO RELATED APPLICATIONS

The present application is a national phase application of International Patent Application No. PCT/JP2023/033672 filed on Sep. 15, 2023, which claims the benefit of Japanese Patent Application No. 2022-148368, filed on Sep. 16, 2022. The contents of the above applications are incorporated herein by reference in their entirety.

### BACKGROUND

### Technical Field

The present disclosure relates to a hub seal.

### Related Art

In a vehicle, for example, an automobile, a hub bearing rotatably supporting a wheel is in an environment where the hub bearing is directly exposed to foreign bodies such as rain water, muddy water, and dust. Thus, in related art, a hub seal as a sealing device is mounted on a hub bearing in order to intend sealing of a space which is formed between an outer ring capable of relative rotation about an axis line and a hub. The hub seal is intended to perform sealing for a lubricant in an internal portion of the hub bearing and is intended to prevent foreign bodies from entering the internal portion. Further, reduction in sliding resistance (torque resistance) of a seal lip against rotation of the hub seal has been demanded for such a hub seal in order to reduce torque necessary for rotation of the hub seal due to a request for reduction in fuel consumption and so forth. Thus, there have been some hub seals in related art which are intended to reduce the torque resistance (for example, see Registered Utility Model No. 3201207).

In order to reduce torque resistance of a hub seal, a measure is possible in which force that a seal lip fastens an outer peripheral surface of a hub (lip reaction force of the seal lip) is reduced; however, because lowering of the lip reaction force of the seal lip lowers seal performance, there is a limit, for maintaining needed seal performance, to reduction in the lip reaction force of the seal lip. As described above, in the hub seal of a hub bearing in related art, in order to maintain the needed seal performance, there is a limit to reduction in the lip reaction force of the seal lip, and there is a limit to reduction in torque of the hub seal. Thus, a configuration which can lower the limit, for maintaining the needed seal performance, to reduction in the torque of the hub seal has been demanded for the hub seal of the hub bearing in related art.

An object of the present disclosure is to provide a hub seal that can lower a limit, for maintaining needed seal performance, to reduction in torque of the hub seal.

### SUMMARY

For solving the above problem, a hub seal according to the present disclosure is a hub seal having a side lip and being intended for sealing of a space between an outer ring and a hub of a hub bearing, the hub seal being characterized in that a value (torque T/shaft-diameter D) resulting from division of torque T as a value of torque of the hub seal in the hub bearing, which rotates at a rotation speed in a predetermined range, by a shaft diameter D as a value of a diameter of a shaft of the hub bearing is equal to or lower than 3 N, a value of a muddy-water durable sliding distance is equal to or longer than 3,000 km, and the muddy-water durable sliding distance is a distance for which the side lip slides until a foreign body oozes out to a sealing target object side.

In the hub seal according to one aspect of the present disclosure, the side lip has such a shape that the torque T in a case where the hub bearing rotates at a rotation speed in a predetermined range becomes smaller than the torque T in a case where the hub bearing rotates at a lower rotation speed than the rotation speed in the predetermined range, and a magnitude of the torque T made smaller is set based on a position to which a foreign body entering an internal portion of the hub seal is moved to an outer periphery side by rotation of the hub bearing.

In the hub seal according to one aspect of the present disclosure, the side lip rotates together with one of the outer ring and the hub, which rotates, and a surface facing an inner periphery side becomes a contact surface for the sealing.

The hub seal according to one aspect of the present disclosure further includes a sleeve as an annular member, the sleeve is fixed to one of the outer ring and the hub, which does not rotate, and the contact surface of the side lip contacts the sleeve for the sealing.

In the hub seal according to one aspect of the present disclosure, the torque of the hub seal is torque which is necessary for rotating the hub seal against sliding resistance of the side lip based on lip reaction force as a value of reaction force of the side lip.

In the hub seal according to one aspect of the present disclosure, one of the outer ring and the hub, which rotates, has the shaft of the hub bearing.

### Advantageous Effect of Disclosure

A hub seal according to the present disclosure can lower a limit, for maintaining needed seal performance, to reduction in torque of the hub seal.

### BRIEF DESCRIPTION OF THE DRAWINGS

FIG. 1 is a cross-sectional view in a cross section, along an axis line, of a hub seal according to a first embodiment of the present disclosure.

FIG. 2 is an enlarged cross-sectional view illustrating a side lip of the hub seal illustrated in FIG. 1 while enlarging the side lip.

FIG. 3 is a partially enlarged cross-sectional view of the side lip.

FIG. 4 is a cross-sectional view of a hub bearing in a cross section along the axis line for illustrating a usage state of the hub seal mounted on the hub bearing.

FIG. 5 is a partially enlarged cross-sectional view of the vicinity of the hub seal in FIG. 4.

FIG. 6 is a schematic diagram for explaining a shake-off action, for foreign bodies, of the hub seal.

FIG. 7 is a diagram illustrating a graph representing ranges of a value of torque/shaft-diameter and of a value of foreign-body durable sliding distance in the hub seal according to the first embodiment of the present disclosure.

FIG. 8 is a diagram illustrating a graph representing a relationship between torque of the hub seal and a rotational speed of the hub seal and a relationship between a foreign-body surface position and the rotation speed of the hub seal.

FIG. 9 is a cross-sectional view illustrating one example of a basic hub seal in a cross section of the basic hub seal along an axis line.

FIG. 10 is a partial cross-sectional view illustrating a side lip of the basic hub seal while enlarging the side lip.

FIG. 11 is a diagram illustrating a graph representing a relationship between a thickness of a tip end portion of the side lip and torque performance.

FIG. 12 is a diagram illustrating a graph representing a relationship between a thickness of a root portion of the side lip and the torque performance.

FIG. 13 is a view illustrating an outline configuration of an evaluation device for measuring the torque and a muddy-water durable sliding distance of the hub seal according to the first embodiment of the present disclosure.

FIG. 14 is a cross-sectional view in a cross section, along an axis line, of a hub seal according to a second embodiment of the present disclosure.

FIG. 15 is a cross-sectional view of one example of an in-wheel motor unit for which the hub seal according to the embodiment of the present disclosure is used.

### DETAILED DESCRIPTION

Embodiments of the present disclosure will hereinafter be described in detail with reference to drawings.

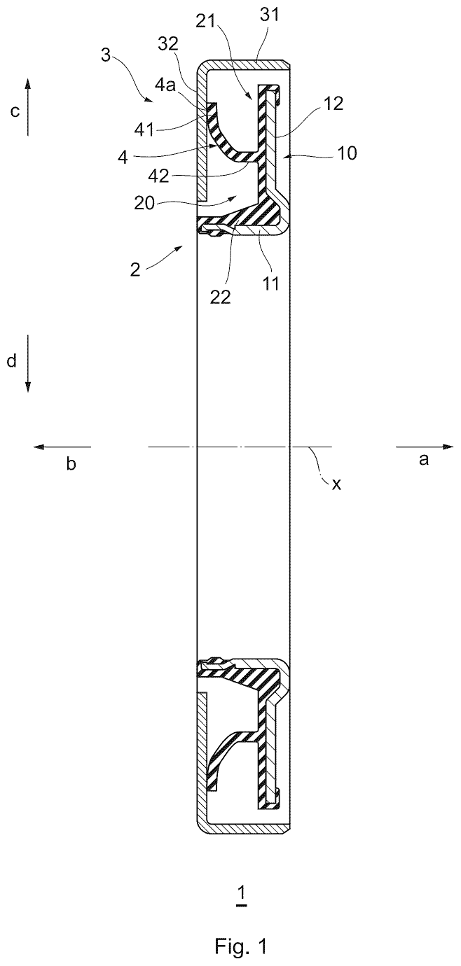

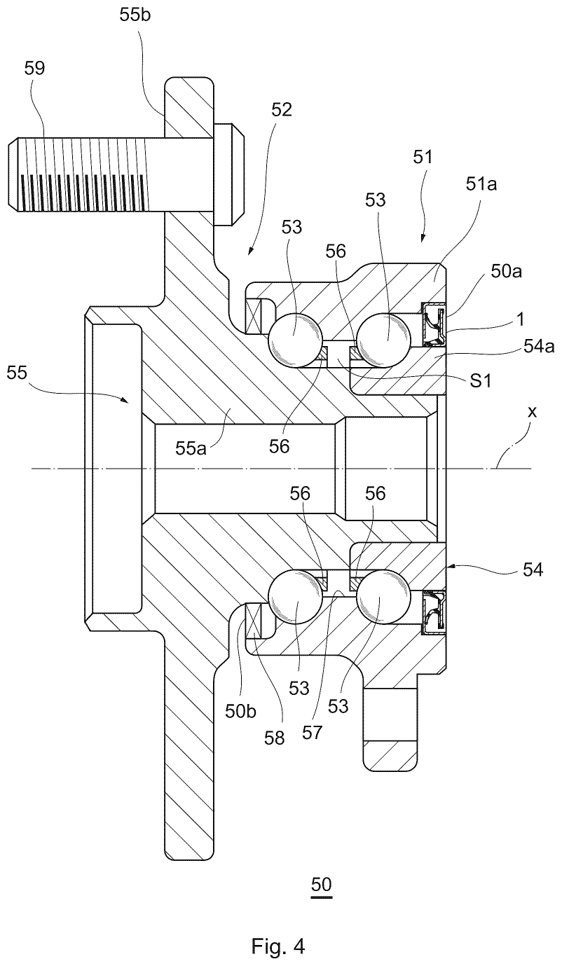

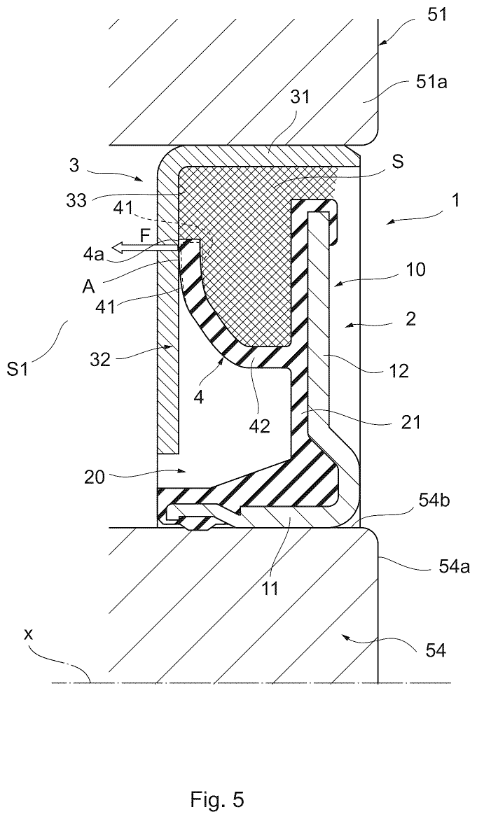

FIG. 1 is a view illustrating one example of a hub seal according to the present disclosure and is a cross-sectional view in a cross section, along an axis line x, of a hub seal 1 (hereinafter, also simply referred to as a cross section) according to a first embodiment of the present disclosure. Note that in FIG. 1, the hub seal 1 is illustrated in a usage state. The hub seal according to the present disclosure is a sealing device that has a side lip and is intended for sealing of a space between an outer periphery side member and an inner periphery side member which is at least partially surrounded by the outer periphery side member, the outer periphery side member and the inner periphery side member being capable of relative rotation to each other. As specifically described later, the hub seal 1 according to the first embodiment of the present disclosure is used for a hub bearing 50 for an automobile and is used for sealing a space between an outer ring 51 as the outer periphery side member and a hub 52 as the inner periphery side member, the outer periphery side member being capable of relative rotation about an axis line (see FIGS. 4 and 5). Note that a mounting target of the hub seal according to the present disclosure is not limited to a hub bearing for a vehicle such as an automobile, and the hub seal according to the present disclosure is applicable to other bearings, which are not a hub bearing for a vehicle, such as bearings to be used for industrial machines, general-purpose machines, and so forth, for example.

Hereinafter, for convenience of description, a side of an arrow a (see FIG. 1) direction in the axis line x direction is set as an outer side, and a side of an arrow b (see FIG. 1) direction in the axis line x is set as an inner side. More specifically, the outer side denotes a side in a direction moving away from the space between the outer ring 51 and the hub 52 as a sealing target space, and the inner side denotes a side in a direction moving close to the sealing target space in the axis x direction. Further, in a direction perpendicular to the axis line x (hereinafter, also referred to as a “radial direction”), a side in a direction moving away from the axis line x (arrow c direction in FIG. 1) is set as an outer periphery side, and a side in a direction moving close to the axis line x (arrow d direction in FIG. 1) is set as an inner periphery side.

As illustrated in FIG. 1, the hub seal 1 is a hub seal which has a side lip 4 and is intended for sealing of the space between the outer ring 51 and the hub 52 of the hub bearing 50 as described later (see FIGS. 4 and 5). In the hub seal 1, a value (torque T/shaft-diameter D) resulting from division of torque T as a value of torque of the hub seal 1 in the hub bearing 50, which rotates at a rotation speed in a predetermined range, by a shaft diameter D as a value of a diameter of a shaft of the hub bearing 50 is equal to or lower than 3 N, and a value of a muddy-water durable sliding distance is equal to or longer than 3,000 km. Hereinafter, a configuration of the hub seal 1 will specifically be described.

The torque of the hub seal 1 is torque which is necessary for rotating the hub seal 1 against sliding resistance of the side lip 4 based on lip reaction force F as a value of reaction force of the side lip 4. Further, one of the outer ring 51 and the hub 52, which rotates, has a shaft of the hub bearing 50. Further, the side lip 4 rotates together with one of the outer ring 51 and the hub 52, which rotates, and a surface facing the inner periphery side becomes a contact surface for sealing. In the hub bearing 50, the outer ring 51 is on a fixed side, the hub 52 is on a rotating side, and the hub 52 rotates with respect to the outer ring 51. The muddy-water durable sliding distance is a distance for which the side lip 4 slides with respect to a slinger 3 until a foreign body such as rain water, muddy water, or dust leaks out to the sealing target space beyond the hub seal 1.

The side lip 4 has such a shape that the torque T in a case where the hub bearing 50 rotates at the rotation speed in the predetermined range becomes smaller than the torque T in a case where the hub bearing 50 rotates at a lower rotation speed than the rotation speed in the predetermined range. Further, a magnitude of the torque T made smaller is set based on a position to which the foreign body such as rain water, muddy water, or dust, which enters an internal portion of the hub seal 1, is moved to the outer periphery side by rotation of the hub bearing 50. The above rotation speed of the hub bearing 50 in the predetermined range is a practical rotation speed of the hub bearing 50, for example.

As illustrated in FIG. 1, for example, the hub seal 1 specifically includes a seal main body 2 as a first seal member to be mounted on the hub 52 as the rotating side of the hub bearing 50 and a sleeve 3 as a second seal member to be mounted on the outer ring 51 as the fixed side of the hub bearing 50. The seal main body 2 and the sleeve 3 are members which are annular around the axis line x. The seal main body 2 has the side lip 4 which is annular around the axis line x. Note that as described above, in FIG. 1, the seal main body 2 and the sleeve 3 are illustrated in relative positions in the usage state.

For example, as illustrated in FIG. 1, the seal main body 2 includes a reinforcement ring 10 as a member which is annular around the axis line x and an elastic body portion 20 that is mounted on the reinforcement ring 10 and is formed with an elastic body which is annular around the axis line x. The elastic body portion 20 has the side lip 4. In the usage state, which will be described later, where the hub seal 1 is mounted on the hub bearing 50, the side lip 4 is a seal lip which is formed to contact the sleeve 3 from the outer side (arrow a direction side) and extends toward the inner side (arrow b direction side).

For example, as illustrated in FIG. 1, the reinforcement ring 10 is a member, which is formed of metal and has a circular ring shape or a generally circular ring shape which has the axis line x as a center or a general center, and is formed such that the hub 52 of the hub bearing 50 serving as the mounting target and described later is press-fitted into the reinforcement ring 10 and the reinforcement ring 10 is fitted into the hub 52 and fitted thereon. The reinforcement ring 10 has a tubular portion 11 as a portion which is tubular and is positioned on the inner periphery side and a circular ring portion 12 as a portion which is annular and extends from an end portion of the tubular portion 11 on the outer side to the outer periphery side, for example. The tubular portion 11 has such a shape that the hub 52 is fitted in the tubular portion 11 in an interference fit manner so that the reinforcement ring 10 is fitted on the hub 52 as described above. Further, the circular ring portion 12 has a portion having a circular ring shape or a generally circular ring shape which expands in parallel or generally parallel in the radial direction. The elastic body portion 20 is mounted on the reinforcement ring 10 substantially from the outer periphery side and the inner side, and the elastic body portion 20 is thereby reinforced. Note that a material of the reinforcement ring 10 is not limited to metal.

For example, as illustrated in FIG. 1, the elastic body portion 20 has a base body portion 21 as a portion mounted on a portion, on the outer periphery side, of the circular ring portion 12 of the reinforcement ring 10 and a tubular-shaped portion 22 as a portion mounted on a portion, on the inner periphery side, of the circular ring portion 12 of the reinforcement ring 10 and the tubular portion 11. In the elastic body portion 20, the side lip 4 extends from the base body portion 21. The elastic body portion 20 is a member integrally formed of the same elastic material, and the side lip 4, the base body portion 21, and the tubular-shaped portion 22 are parts of the elastic body portion 20 which is integrally formed.

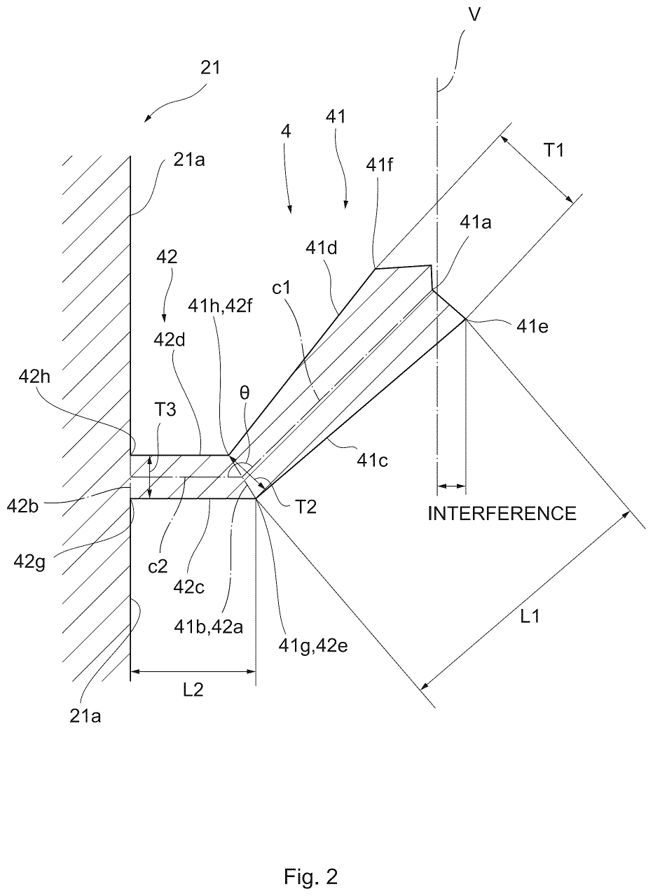

FIG. 2 is an enlarged cross-sectional view illustrating while enlarging the side lip 4. In FIG. 2, the side lip 4 is illustrated in a natural state where the side lip 4 does not contact the sleeve 3 and no external force is exerted. As illustrated in FIGS. 1 and 2, the side lip 4 extends from the base body portion 21 toward the inner side in an annular shape while having the axis line x as a center axis or a general center axis, a surface (inner peripheral surface 41c) facing the inner periphery side of the side lip 4 forms a contact surface 4a for sealing of the space between the outer ring 51 and the hub 52. Further, in the usage state of the hub seal 1, which will be described later, the side lip 4 is formed such that the contact surface 4a of a tip end portion 41 contacts a contact surface 33, which will be described later, of the sleeve 3 while having a predetermined interference.

As illustrated in FIGS. 1 and 2, the side lip 4 has the tip end portion 41 and a root portion 42. The root portion 42 is a portion connected with the base body portion 21 of the side lip 4, and the tip end portion 41 is a portion which is positioned on a tip end side (inner side) relative to the root portion 42 of the side lip 4. The root portion 42 extends in parallel or generally parallel with the axis line x and has a cylindrical or generally cylindrical shape having the axis line x as a central axis or a generally central axis as illustrated in FIG. 2, for example. The tip end portion 41 has a shape which has the axis line x as a central axis or a generally central axis and whose diameter is expanded as progress toward the inner side along the axis line x.

As illustrated in FIG. 2, in a cross section of the tip end portion 41, a thickness of an end (tip end 41a) on the tip end side is a thickness T1, and a thickness of an end (rood end 41b) on a root end side is a thickness T2. Note that the root end 41b is a virtual end of the tip end portion 41. As illustrated in FIG. 2, in the cross section, the tip end portion 41 extends along an extending direction line c1 as a virtual line and has a shape symmetrical or generally symmetrical with respect to the extending direction line c1. In other words, the inner peripheral surface 41c as the surface facing the inner periphery side of the tip end portion 41 and an outer peripheral surface 41d as a surface facing the outer periphery side of the tip end portion 41 are symmetrical or generally symmetrical with respect to the extending direction line c1. For example, as illustrated in FIG. 2, the extending direction line c1 is a straight line which is inclined with respect to the axis line x to be inclined to the outer periphery side toward the inner side. Note that the extending direction line c1 does not have to be a straight line and may be a curve, a line in which a straight line and a curve are combined, or the like. Further, the inner peripheral surface 41c and the outer peripheral surface 41d partially do not have to be symmetrical with respect to the extending direction line c1 or do not have to be symmetrical with respect to the extending direction line c1.

The thicknesses T1 and T2 are widths between the inner peripheral surface 41c and the outer peripheral surface 41d in a direction orthogonal to the extending direction line c1. Specifically, for example, as illustrated in FIG. 2, the thickness T1 is the width, in the direction orthogonal to the extending direction line c1, between an inner periphery tip end 41e as the tip end 41a in the inner peripheral surface 41c and an outer periphery tip end 41f as the tip end 41a in the outer peripheral surface 41d. Further, the thickness T2 is the width, in the direction orthogonal to the extending direction line c1, of an outer periphery root end 41h as the rood end 41b in the outer peripheral surface 41d.

Further, a length of the tip end portion 41 in a direction of the extending direction line c1 is a length L1. Specifically, for example, as illustrated in FIG. 2, the length L1 of the tip end portion 41 is the length, in the direction of the extending direction line c1, between the inner periphery tip end 41e and an inner periphery root end 41g. Note that the inner periphery root end 41g is the root end 41b in the inner peripheral surface 41c. Further, the length L1 of the tip end portion 41 may be a length, in the direction of the extending direction line c1, between the outer periphery tip end 41f and the outer periphery root end 41h.

As illustrated in FIG. 2, in a cross section of the rood portion 42, a thickness of the root portion 42 is a uniform thickness (thickness T3). The thickness of the root portion 42 may be generally uniform with respect to the thickness T3. As illustrated in FIG. 2, in the cross section, the root portion 42 extends along an extending direction line c2 as a virtual line and has a shape symmetrical or generally symmetrical with respect to the extending direction line c2. In other words, an inner peripheral surface 42c as a surface facing the inner periphery side of the root portion 42 and an outer peripheral surface 42d as a surface facing the outer periphery side of the root portion 42 are symmetrical or generally symmetrical with respect to the extending direction line c2. For example, as illustrated in FIG. 2, the extending direction line c2 is a straight line which is parallel or generally parallel with the axis line x. Note that the extending direction line c2 does not have to be a straight line and may be a curve, a line in which a straight line and a curve are combined, or the like. Further, the inner peripheral surface 42c and the outer peripheral surface 42d partially do not have to be symmetrical with respect to the extending direction line c2 or do not have to be symmetrical with respect to the extending direction line c2. Further, the extending direction line c2 may be inclined with respect to the axis line x.

The thickness T3 is a width between the inner peripheral surface 42c and the outer peripheral surface 42d in a direction orthogonal to the extending direction line c2. Specifically, for example, as illustrated in FIG. 2, the thickness T3 is the width between an arbitrary point on the inner peripheral surface 42c or the outer peripheral surface 42d and a point on the outer peripheral surface 42d or the inner peripheral surface 42c, the point being opposed to the above point in the direction orthogonal to the extending direction line c2. The thickness T3 may be the width, in the direction orthogonal to the extending direction line c2, between an inner periphery root end 42g as an end (root end 42b) in the inner peripheral surface 42c on the base body portion 21 side and an outer peripheral root end 42h as the root end 42b in the outer peripheral surface 42d, and the thickness T3 may be the width, in the direction orthogonal to the extending direction line c2, between an inner periphery tip end 42e as an end (tip end 42a) in the inner peripheral surface 42c on the tip end portion 41 side and an outer periphery tip end 42f as the tip end 42a in the outer peripheral surface 42d. Note that the tip end 42a and the root end 42b are virtual ends of the root portion 42.

Further, a length of the root portion 42 in a direction of the extending direction line c2 is a length L2. Specifically, for example, as illustrated in FIG. 2, the length L2 of the root portion 42 is the length, in the direction of the extending direction line c2, between the inner periphery tip end 42e and the inner periphery root end 42g. Further, the length L2 of the root portion 42 may be a length, in the direction of the extending direction line c2, between the outer periphery tip end 42f and the outer periphery root end 42h.

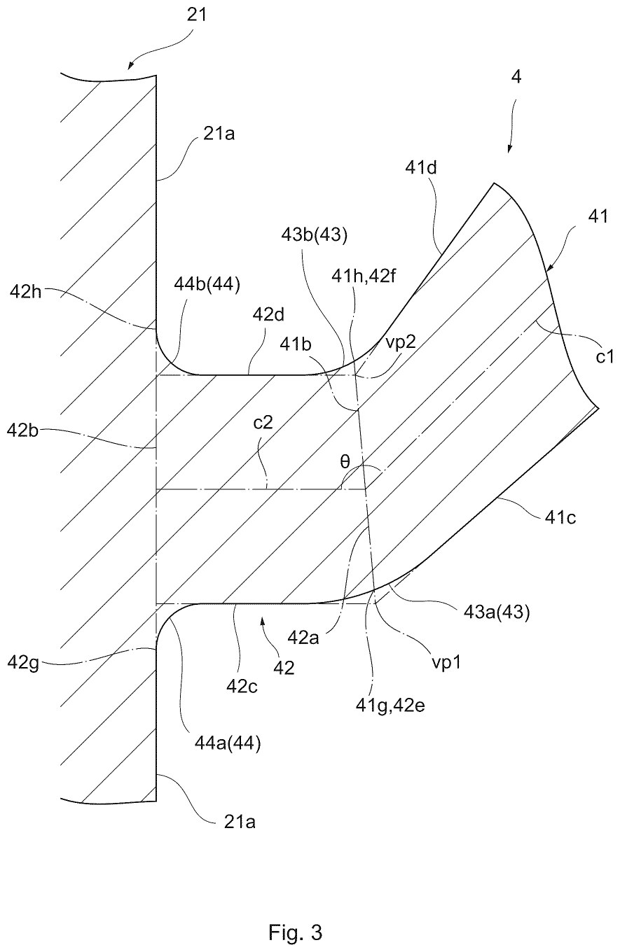

As illustrated in FIG. 3, between the tip end portion 41 and the root portion 42, a transition portion 43 may be formed such that the tip end portion 41 and the root portion 42 are smoothly connected. Further, as illustrated in FIG. 3, between the root portion 42 and the base body portion 21, a transition portion 44 may be formed such that the root portion 42 and the base body portion 21 are smoothly connected. Specifically, as illustrated in FIG. 3, the transition portion 43 includes an inner periphery transition surface 43a as a surface, which connects the inner peripheral surface 41c of the tip end portion 41 with the inner peripheral surface 42c of the root portion 42, and an outer periphery transition surface 43b as a surface, which connects the outer peripheral surface 41d of the tip end portion 41 with the outer peripheral surface 42d of the root portion 42. For example, as illustrated in FIG. 3, in a cross section, the inner periphery transition surface 43a has a shape which forms a curve protruding to the inner periphery side. For example, as illustrated in FIG. 3, in the cross section, the outer periphery transition surface 43b has a shape which forms a curve recessed to the inner periphery side.

Specifically, as illustrated in FIG. 3, the transition portion 44 includes an inner periphery transition surface 44a as a surface, which connects the inner peripheral surface 42c of the root portion 42 with an inner side surface 21a of the base body portion 21, and an outer periphery transition surface 44b as a surface, which connects the outer peripheral surface 42d of the root portion 42 with the inner side surface 21a of the base body portion 21. For example, as illustrated in FIG. 3, in the cross section, the inner periphery transition surface 44a has a shape which forms a curve recessed to the outer periphery side. For example, as illustrated in FIG. 3, in the cross section, the outer periphery transition surface 44b has a shape which forms a curve recessed to the inner periphery side.

In this case, for example, as illustrated in FIG. 3, in the cross section, the root end 41b of the tip end portion 41 and the tip end 42a of the root portion 42 pass through a virtual intersection point vp1 between a virtual extension line of the inner peripheral surface 41c of the tip end portion 41 and a virtual extension line of the inner peripheral surface 42c of the root portion 42 and a virtual intersection point vp2 between a virtual extension line of the outer peripheral surface 41d of the tip end portion 41 and a virtual extension line of the outer peripheral surface 42d of the root portion 42.

As illustrated in FIG. 2, in the tip end portion 41, for example, the thickness Tl is larger than the thickness T2, the tip end portion 41 has such a shape that the thickness of the tip end portion 41 becomes thicker as progress from the root end 41b toward the tip end 41a along the extending direction line c1. Note that in the cross section, the thickness of the tip end portion 41 is a width between the inner peripheral surface 41c and the outer peripheral surface 41d in the direction orthogonal to the extending direction line c1. Further, as illustrated in FIG. 2, an angle (bent angle θ) between the extending direction line c1 and the extending direction line c2 is an angle which is larger than 90° and smaller than 180° (90°<θ<180°).

Further, as illustrated in FIG. 2, in the rood portion 42, the thickness T3 is uniform throughout the length L2, for example. Further, the thickness T3 of the root portion 42 is smaller than the thickness T2 of the root end 41b of the tip end portion 41, for example. Note that the thickness T3 of the root portion 42 may be larger than the thickness T2 of the root end 41b of the tip end portion 41.

The side lip 4 has the above-described shape, and in the usage state described later, a portion, on the tip end 41a side, of the inner peripheral surface 41c of the tip end portion 41 contacts the contact surface 33 of the sleeve 3 in the interference (contact surface 4a) having a predetermined size and thereby generates the reaction force (lip reaction force) of a predetermined magnitude. The interference of the seal lip has a length in which the seal lip in a free state, which is not deformed by external force, projects relatively to a contact surface that the seal lip contacts in the usage state. Specifically, the interference of the side lip 4 has a length, in the axis line x direction, of a portion of the inner peripheral surface 41c of the tip end portion 41 of the side lip 4, the portion protruding relatively to the contact surface 33 of the sleeve 3 as a contact surface indicated by a virtual line V in FIG. 2.

The elastic body portion 20 is integrally mounted on the reinforcement ring 10, and the above-described side lip 4 and base body portion 21 are portions of the elastic body portion 20 integrally formed of the same material and are integrally continuous.

For example, as illustrated in FIG. 1, the sleeve 3 is a member, which is formed of metal and has a circular ring shape or a generally circular ring shape which has the axis line x as a center or a general center, and is formed such that the sleeve 3 is press-fitted into the outer ring 51 of the hub bearing 50 serving as the mounting target and described later and the sleeve 3 is fitted into the outer ring 51 and fitted thereon. The sleeve 3 has a tubular portion 31 as a portion which is tubular and is positioned on the outer periphery side and a circular ring portion 32 as a portion which has a circular ring shape or a generally circular ring shape and extends from an end portion of the tubular portion 31 on the inner side to the inner periphery side, for example. The tubular portion 31 has such a shape that the tubular portion 31 is fitted in the outer ring 51 in the interference fit manner so that the sleeve 3 is fitted on the outer ring 51 as described above. Further, the circular ring portion 32 has a portion having a circular ring shape or a generally circular ring shape which expands in parallel or generally parallel in the radial direction. In the circular ring portion 32, the contact surface 33 as a surface that the side lip 4 contacts in the usage state described later is formed. The contact surface 33 is a surface in the circular ring portion 32, which faces the outer side, and is a flat surface or a generally flat surface which expands in parallel or generally parallel with a flat surface orthogonal or generally orthogonal to the axis line x and is annular around the axis line x. Note that a material of the sleeve 3 is not limited to metal.

As described above, the value of torque T/shaft-diameter D (hereinafter, also referred to as unit torque) of the hub seal 1 is equal to or smaller than 3 N, and the value of the muddy-water durable sliding distance of the hub seal 1 is equal to or longer than 3,000 km. Specifically, for example, the hub seal 1 is provided such that the value of the unit torque (torque T/shaft-diameter D) of the hub seal 1 in a range of the practical rotation speed of the hub bearing 50 as the mounting target becomes equal to or smaller than 3 N and such that the muddy-water durable sliding distance in the range of the practical rotation speed of the hub bearing 50 as the mounting target becomes equal to or longer than 3,000 km. In the hub seal 1, as described above, the side lip 4 has such a form that the value of the unit torque (torque/shaft-diameter D) becomes equal to or smaller than 3 N, and an upstream space S has such a form that the muddy-water durable sliding distance becomes equal to or longer than 3,000 km. Note that as described later, the upstream space S is a space in the hub seal 1 on a side away from a sealed space S1 relatively to the side lip 4 (see FIG. 5). Such a form of the side lip 4 and such a form of the upstream space S will be described later.

Further, as described above, the shaft diameter D is a diameter of a shaft of the hub bearing 50, for example, a diameter of the hub 52 of the hub bearing 50 on the rotating side. More specifically, for example, the shaft diameter D is a diameter of an outer peripheral surface 54b of an end portion 54a of an inner ring 54 of the hub 52, on which the seal main body 2 is mounted and which will be described later. The shaft diameter D may be a diameter of another portion of the hub bearing 50 and is a diameter related to a standard of a size of the hub bearing 50, for example. Further, the shaft diameter D may be a diameter corresponding to a diameter of any portion of the hub seal 1.

Next, the above-described usage state of the hub seal 1 will be described. FIG. 4 is a cross-sectional view of the hub bearing 50 in a cross section along the axis line x for illustrating the usage state of the hub seal 1 mounted on the hub bearing 50, and FIG. 5 is a partially enlarged cross-sectional view of the vicinity of the hub seal 1 in FIG. 4. Note that in illustrated examples, an axis line of the hub bearing 50 agrees with the axis line x of the hub seal 1, and the hub bearing 50 has the axis line x common to the hub seal 1.

As illustrated in FIG. 4, the hub bearing 50 is a hub bearing which has been known in related art, is a hub bearing of an inner ring rotation type, is provided in a vehicle or the like such as an automobile, and rotatably supports a wheel on an axle or a suspension device. Specifically, as illustrated in FIG. 4, the hub bearing 50 includes the outer ring 51, as an outer periphery side member, which is annular and has the axis line x as a central axis or a generally central axis, the hub 52, as an inner periphery side member, which is capable of relative rotation to the outer ring 51, is partially surrounded by the outer ring 51, and has the axis line x as a central axis or a generally central axis, and a plurality of bearing balls 53 which are disposed in two lines between the outer ring 51 and the hub 52. In the usage state of the hub bearing 50 mounted on a vehicle or the like, the outer ring 51 is fixed to a suspension device of the vehicle, for example, and the hub 52 becomes capable of relative rotation to the outer ring 51. Specifically, the hub 52 has the inner ring 54 and a hub ring 55, and the hub ring 55 has a shaft portion 55a which is generally cylindrical and extends along the axis line x and a wheel-mounting flange 55b. The wheel-mounting flange 55b is a portion which expands in a circular ring shape from one end of the shaft portion 55a on the outer side toward the outer periphery side and is a portion on which a wheel not illustrated is mounted by a plurality of hub bolts 59. In order to retain the bearing balls 53 in a space between the outer ring 51 and the hub 52, the inner ring 54 is fitted to an end portion, on the inner side, of the shaft portion 55a of the hub ring 55. In the sealed space S1 as the space between the outer ring 51 and the hub 52, the bearing balls 53 are retained by a retainer 56.

The outer ring 51 has a through hole 57 extending in the axis line x direction, the shaft portion 55a of the hub ring 55 of the hub 52 is inserted into the through hole 57, and the sealed space S1 which is annular and extends along the axis line x is formed between the shaft portion 55a and the through hole 57. Further, a lubricant is applied or injected into the sealed space S1. The hub seal 1 is mounted on an inner side opening portion 50a of the hub bearing 50, which forms an opening through which a space between the shaft portion 55a and the through hole 57 is opened to the inner side, and another sealing device 58 is mounted on an outer side opening portion 50b of the hub bearing 50, which forms an opening through which the space between the shaft portion 55a and the through hole 57 is opened to the outer side. Sealing of a space between the shaft portion 55a and inner ring 54 and the through hole 57 is intended by the hub seal 1 and the sealing device 58, prevention of leakage of the lubricant in this sealed space S1 to an outside is intended, and prevention of entry of foreign bodies such as rain water, muddy water, and dust from the outside to an internal portion is intended. The sealing device 58 is a sealing device which has been known in related art, and a detailed description thereof will not be made. Note that as the sealing device 58, the hub seal 1 can be applied. A configuration of a hub bearing to which the hub seal 1 is applied is not limited to a configuration of the above-described hub bearing 50.

As illustrated in FIGS. 4 and 5, specifically, the sleeve 3 of the hub seal 1 is mounted on an end portion 51a, which is cylindrical, of the outer ring 51 on the inner side, the reinforcement ring 10 of the seal main body 2 of the hub seal 1 is mounted on the end portion 54a, which is cylindrical, of the inner ring 54 of the hub 52 on the inner side, and the hub seal 1 is thereby mounted on the hub bearing 50. Specifically, the tubular portion 31 is press-fitted in the inner side opening portion 50a of the outer ring 51 to be fitted thereon, and the sleeve 3 is thereby fixed to the outer ring 51. Further, the end portion 54a of the inner ring 54 is press-fitted in the tubular portion 11 of the reinforcement ring 10, the reinforcement ring 10 is fitted on the inner ring 54, and the seal main body 2 is thereby fixed to the inner ring 54.

In the usage state, the seal main body 2 and the sleeve 3 are positioned such that an interval in the axis line x direction becomes a predetermined interval, a portion, on a tip end side, of the inner peripheral surface 41c of the tip end portion 41 of the side lip 4 slidably contacts the contact surface 33 of the sleeve 3 in a portion (contact surface 4a) corresponding to the above-described predetermined interference. By the side lip 4, prevention of entry of foreign bodies into the sealed space S1 is intended, and prevention of outflow of the lubricant from an inside of the sealed space S1 is intended. Note that in the hub seal 1, grease may be applied to the inner peripheral surface 41c of the side lip 4, and in the usage state, the grease (not illustrated) may thereby be interposed between the contact surface 4a of the side lip 4 and the contact surface 33 of the circular ring portion 32 of the sleeve 3.

As described above, in the usage state, the side lip 4 contacts, in the contact surface 4a, the contact surface 33 of the sleeve 3 in the predetermined interference, and the reaction force (lip reaction force F) based on this contact is generated for the side lip 4. As illustrated in FIG. 5, in the usage state of the hub seal 1, the lip reaction force F of the side lip 4 is force, in the axis line x direction, that the side lip 4 exerts on the contact surface 33 of the circular ring portion 32 of the sleeve 3. The lip reaction force F of the side lip 4 serves as torque resistance against rotation of the hub seal 1. In other words, the torque T of the hub seal 1 is a value corresponding to the lip reaction force F of the side lip 4. As examples of factors defining the lip reaction force F of the side lip 4, the length L1 of the tip end portion 41 of the side lip 4, the thicknesses T1 and T2 of the tip end portion 41 of the side lip 4, the thickness T3 of the root portion 42 of the side lip 4, the bent angle 0 of the side lip 4, and surface roughness of the inner peripheral surface 41c of the tip end portion 41 of the side lip 4, which are illustrated in FIG. 2, are raised.

The lip reaction force F of the side lip 4 changes in accordance with a rotation speed of the hub 52. This is because force in a direction to move the side lip 4 away from the contact surface 33 of the sleeve 3 is generated by centrifugal force which is exerted on the side lip 4 of the seal main body 2, which rotates around the axis line x together with the hub 52, when the hub 52 rotates. The centrifugal force exerted on the side lip 4 becomes larger as the rotation speed of the hub 52 (seal main body 2) becomes higher, in association with that, the force in the direction to move the side lip 4 away from the contact surface 33 of the sleeve 3 becomes larger, and the lip reaction force F of the side lip 4 thereby becomes smaller as the rotation speed of the hub 52 becomes higher. When the rotation speed of the hub 52 becomes higher than a predetermined rotation speed, the force in the direction to move the side lip 4 away from the contact surface 33 of the sleeve 3 reaches a magnitude at which the side lip 4 is moved completely away from the contact surface 33 of the sleeve 3, and the side lip 4 moves away from the contact surface 33 of the sleeve 3.

While corresponding to the change in the lip reaction force F of the side lip 4 according to the rotation speed of the hub 52, the torque T of the hub seal 1 also changes in accordance with the rotation speed of the hub 52. Specifically, for example, when the rotation speed of the hub 52 rises from zero, the torque T of the hub seal 1 rises in accordance with the rise. Furthermore, when the rotation speed of the hub 52 reaches a rotation speed at which the lip reaction force F of the side lip 4 is reduced, a rate of the rise of the torque T, which is associated with the rise of the rotation speed of the hub 52, lowers. When the rotation speed of the hub 52 further rises, the torque T of the hub seal 1 starts decreasing, and the torque T of the hub seal 1 thereafter lowers in association with the rise of the rotation speed of the hub 52. In such a manner, when the rotation speed of the hub 52 reaches a certain rotation speed in a range in which the lip reaction force F of the side lip 4 is reduced based on the rotation speed of the hub 52, the torque T of the hub seal 1 lowers in association with the rise of the rotation speed of the hub 52.

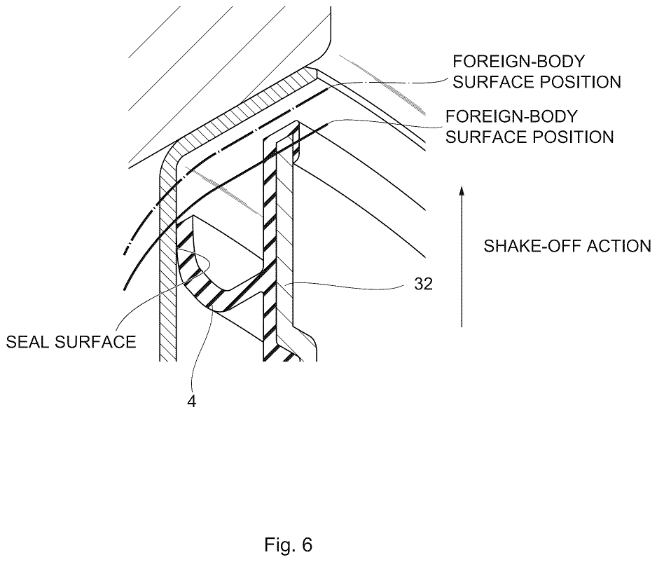

Meanwhile, a shake-off action occurs in the hub seal 1 by centrifugal force generated by rotation of the hub 52. As illustrated in FIG. 6, the shake-off action is an action to move a foreign body entering an inside of the hub seal 1, particularly, a liquid foreign body from the side lip 4 side to the outer periphery side. A foreign-body surface position as a position, at which a foreign body pushed to the outer periphery side by the shake-off action is positioned, changes in accordance with the rotation speed of the hub 52 (seal main body 2). The shake-off action for a foreign body occurs when the hub 52 rotates at a higher rotation speed than a predetermined rotation speed. Further, in a region of a higher rotation speed than this predetermined rotation speed, as the rotation speed of the hub 52 becomes higher, an extent of the shake-off action becomes stronger, and the foreign-body surface position becomes a position further on the outer periphery side, in other words, a position further away from the side lip 4 in the radial direction from the axis line x. As illustrated in FIG. 6, the foreign-body surface position is positioned at a position of a seal surface A in the radial direction up to the predetermined rotation speed of the rotation speed of the hub 52, and when the hub 52 (seal main body 2) rotates at a higher rotation speed than the predetermined rotation speed, the foreign-body surface position moves to the outer periphery side in the radial direction. Note that the seal surface A includes the contact surface 4a of the side lip 4 and the contact surface 33 of the sleeve 3 (see FIG. 5).

The extent of the shake-off action differs depending on the form of the space (upstream space S) in the hub seal 1 on the side away from the sealed space S1 relatively to the side lip 4. The upstream space S is a portion indicated by a mesh pattern in FIG. 5 and is a space which is formed between the seal main body 2 and the sleeve 3 on an upstream side relative to the side lip 4.

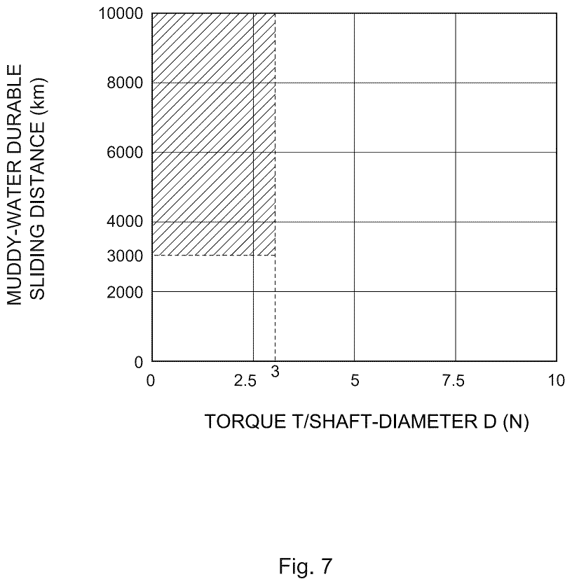

In the hub seal 1, in the practical rotation speed of the hub bearing 50, based on a relationship between the torque T of the hub 52, which changes in accordance with the rotation speed of the hub 52 due to an action of centrifugal force, and the foreign-body surface position, which changes in accordance with the rotation speed of the hub 52 due to the action of the centrifugal force, as illustrated in FIG. 7, the value of the unit torque (torque T/shaft-diameter D) of the hub seal 1 at the practical rotation speed of the hub 52 is equal to or smaller than 3 N, and the value of the muddy-water durable sliding distance at the practical rotation speed of the hub 52 is equal to or longer than 3, 000 km. The lip reaction force of the side lip serves as the torque resistance against rotation of the hub seal and influences the torque of the hub seal. Thus, in the hub seal 1, specifically, the side lip 4 has a form which is adjusted such that the value of the unit torque (torque T/shaft-diameter D) of the hub seal 1 at the practical rotation speed of the hub 52 becomes equal to or smaller than 3 N. Further, in the hub seal 1, specifically, the upstream space S has a form which is adjusted such that the value of the muddy-water durable sliding distance at the practical rotation speed of the hub 52 becomes equal to or longer than 3,000 km.

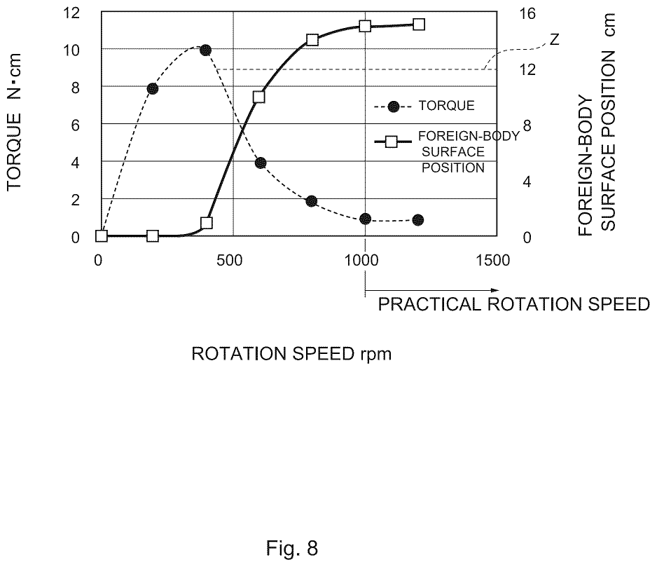

In the hub seal 1, the shape of the side lip 4 is such a shape that a relationship between the torque T of the hub seal 1 and the rotation speed of the hub 52 (seal main body 2) becomes a relationship as represented by a graph in FIG. 8, for example. Further, in the hub seal 1, the shape of the upstream space S is such a shape that a relationship between the foreign-body surface position and the rotation speed of the hub 52 (seal main body 2) becomes a relationship as represented by the graph in FIG. 8, for example. Note that in FIG. 8, the foreign-body surface position is represented by a distance from the seal surface A (see FIG. 5) in the radial direction. Further, the practical rotation speed of the hub bearing 50 is equal to or higher than 1,000 rpm, for example.

As illustrated in FIG. 8, at the practical rotation speed of the hub bearing 50, the hub seal 1 can sufficiently push the foreign-body surface position to the outer periphery side by the shake-off action.

Accordingly, at the practical rotation speed of the hub bearing 50, the foreign-body surface position is high, and no foreign body is present in the vicinity of the seal surface A, or few foreign bodies are present in the vicinity of the seal surface A. Thus, as illustrated in FIG. 8, at the practical rotation speed of the hub bearing 50, the side lip 4 can be provided in which the lip reaction force Flowers by the action of the centrifugal force, and the torque T of the hub seal 1 can be reduced to torque equal to or smaller than approximately 1 N·cm. Further, as illustrated in FIG. 8, at the practical rotation speed of the hub bearing 50, the foreign-body surface position can be pushed to a position of approximately 15 cm on an outer side in the radial direction from the axis line x by the action of the centrifugal force, and no foreign body is present in the vicinity of the seal surface A, or few foreign bodies are present in the vicinity of the seal surface A. Thus, even when in a case where the foreign-body surface position is present in the vicinity of the seal surface A, the lip reaction force F of the side lip 4 becomes so low that entry of the foreign body is allowed, the foreign body does not enter the sealed space S1 side beyond the side lip 4, and seal performance of the hub seal 1 does not become lower than desired seal performance.

Thus, as illustrated in FIG. 7, in the hub seal 1, even when the value of the unit torque (torque T/shaft-diameter D) of the hub seal 1 at the practical rotation speed of the hub 52 is reduced to a value equal to or smaller than 3 N, the value of the muddy-water durable sliding distance at the practical rotation speed of the hub 52 can be set to a value equal to or longer than 3,000 km. In such a manner, while maintaining needed seal performance, the hub seal 1 can reduce the lip reaction force F of the side lip 4 to lip reaction force smaller than a lower limit value of lip reaction force of a side lip of a hub seal in related art for maintaining the needed seal performance.

On one hand, when the hub bearing 50 rotates at a lower rotation speed than the practical rotation speed, a situation occurs where the extent of the shake-off action lowers, the foreign-body surface position becomes close to the position of the seal surface A or is positioned at the seal surface A, the foreign-body surface position is low, and the foreign body is present in the vicinity of the seal surface A. On the other hand, as illustrated in FIG. 8, when the hub bearing 50 rotates at a lower rotation speed than the practical rotation speed, the lip reaction force F is higher than the lip reaction force F at the practical rotation speed such that sufficient seal performance can be retained. Thus, even in a rotation region of the hub bearing 50 in which the extent of the shake-off action is low and the foreign-body surface position becomes low, the foreign body does not enter the sealed space S1 side beyond the side lip 4, and the seal performance of the hub seal 1 does not become lower than the desired seal performance.

The lip reaction force of the side lip serves as the torque resistance against rotation of the hub seal and influences torque performance of the hub seal. Consequently, a form factor such as the shape of the side lip which influences the lip reaction force of the side lip serves as s a form factor of the side lip which influences the torque performance of the hub seal. Note that the torque performance of the hub seal is based on a relationship between the rotation speed of the hub seal and torque necessary for rotation of the hub seal at each rotation speed. Further, a magnitude of the centrifugal force to be exerted on the side lip 4 is influenced by the form of the side lip 4. Thus, in the hub seal 1, specifically, for example, the lip reaction force F of the side lip 4 is set such that the value of the unit torque (torque T/shaft-diameter D) of the hub seal 1 in the range of the practical rotation speed becomes equal to or smaller than 3 N, and the form factor of the side lip 4 is adjusted such that the above set lip reaction force F is obtained.

The lip reaction force F to be set is the lip reaction force F in a case where the hub bearing 50 stands still, for example. The lip reaction force F of the side lip 4 whose form factor is adjusted can be calculated by a computer analysis, for example. Thus, whether or not the lip reaction force F of the side lip 4 whose form factor is adjusted has desired lip reaction force F can be checked by the computer analysis. Whether or not the lip reaction force F of the side lip 4 whose form factor is adjusted has the desired lip reaction force F can also be checked by mounting the hub seal 1 on the hub bearing 50 and measuring the lip reaction force F of the side lip 4.

Adjustment of the form factor of the side lip 4 for setting the value of the unit torque (torque T/shaft-diameter D) of the hub seal 1 in the range of the practical rotation speed to a value equal to or smaller than 3 N can be performed by calculating the lip reaction force F of the side lip 4 or the torque T of the hub seal 1 at each rotation speed of the hub 52 (seal main body 2) by the computer analysis and by checking a calculated value, for example. Note that the torque of the hub seal 1 at each rotation speed can be calculated or estimated from the lip reaction force F at each rotation speed which is calculated by the computer analysis.

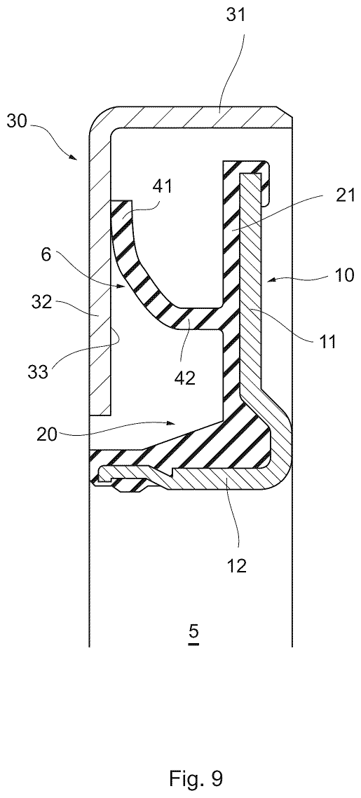

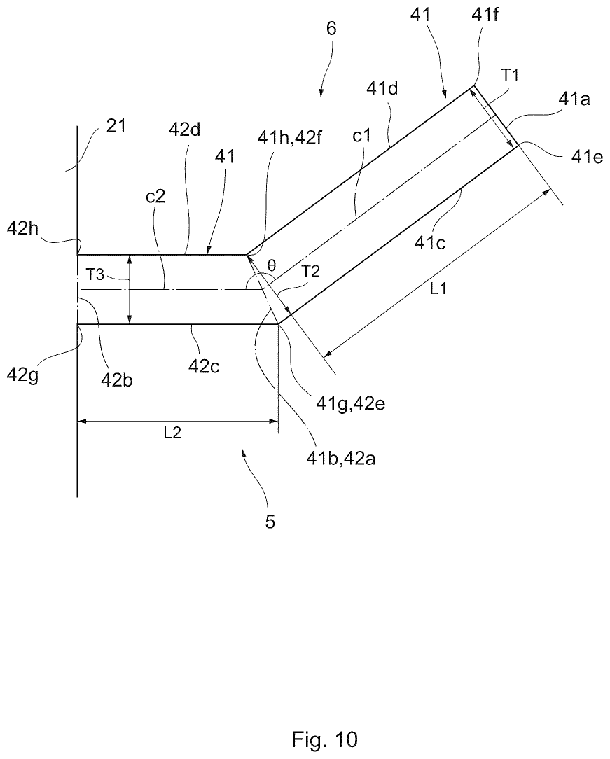

The adjustment of the form factor of the side lip 4 is performed by adjusting a form factor of a side lip 6 of a basic hub seal 5 illustrated in FIGS. 9 and 10, for example. FIG. 9 is a cross-sectional view illustrating one example of the basic hub seal 5 in a cross section of the basic hub seal 5 along the axis line x, and FIG. 10 is a partial cross-sectional view illustrating the side lip 6 of the basic hub seal 5 while enlarging the side lip 6. Only the cross section on one side with respect to the axis line x is illustrated in FIG. 9. Further, in FIG. 9, the seal main body 2 and the sleeve 3 are illustrated in the relative positions in the usage state. The basic hub seal 5 is different only in the shape of the side lip from the above-described hub seal 1 and has the side lip 6 in which the thickness of the tip end portion 41 is uniform throughout the length L1 as illustrated in FIGS. 9 and 10. Sizes and shapes of the reinforcement ring 10 and the sleeve 3 of the basic hub seal 5 are sizes and shapes corresponding to a space on which the hub seal of the hub bearing 50 as the mounting target is mounted.

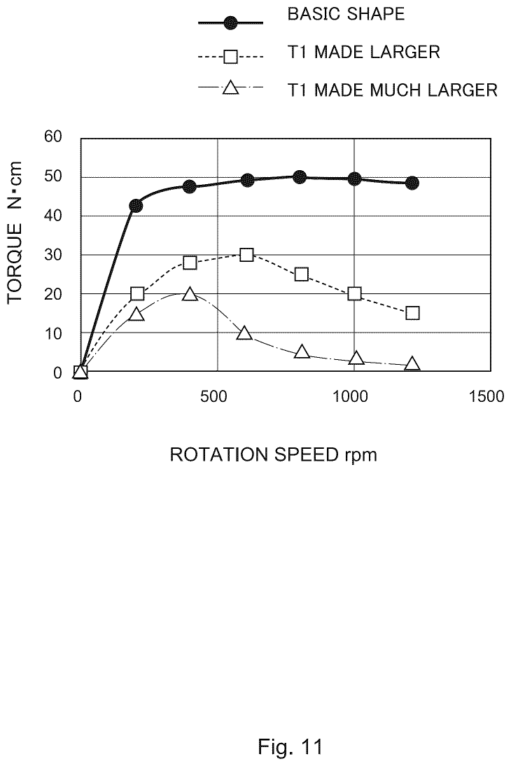

A description will be made about one example of adjustment of the lip reaction force For the torque T by the adjustment of the form factor of the side lip 6. FIG. 11 is a diagram illustrating a graph representing a relationship between the thickness T1, to be adjusted, of the tip end portion 41 of the side lip 6 and the torque T. As illustrated in FIG. 11, as the thickness Tl of the tip end portion 41 of the side lip 6 is adjusted to a larger value, torque of the basic hub seal 5 in a high rotation speed region further lowers. In other words, as the value of the thickness T1 of the tip end portion 41 of the side lip 6 for which form adjustment is performed becomes larger, the centrifugal force acting on the tip end portion 41 of the side lip 6 becomes larger, and the tip end 41a of the tip end portion 41 of the side lip 6 becomes more likely to be moved away from the contact surface 33 of the sleeve 3.

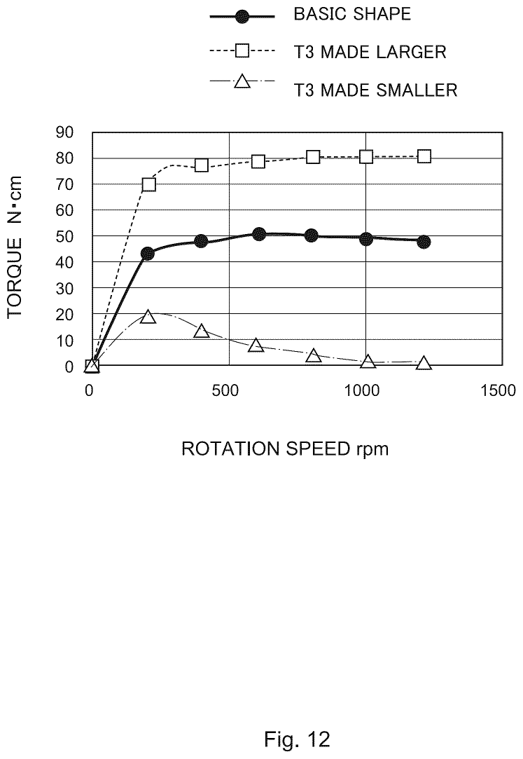

FIG. 12 is a diagram illustrating a graph representing a relationship between the thickness T3, to be adjusted, of the root portion 42 of the side lip 6 and the torque T. As illustrated in FIG. 12, as the thickness T3 of the root portion 42 of the side lip 6 is adjusted to a larger value, the torque T in the high rotation speed region further rises. In other words, as the value of the thickness T3 of the root portion 42 of the side lip 6 for which form adjustment is performed becomes larger, the side lip 6 becomes less likely to be curved, and even when the centrifugal force acts on the tip end portion 41 of the side lip 6, the tip end 41a of the tip end portion 41 of the side lip 6 becomes less likely to be moved away from the contact surface 33 of the sleeve 3.

Further, as the length L2 of the root portion 42 of the side lip 6 is adjusted to a larger value, the torque T in the high rotation speed region further lowers. However, this occurs in a case where the thickness T1 of the tip end portion 41 is sufficiently larger than the thickness T3 of the root portion 42. In other words, as the value of the length L2 of the root portion 42, which has a small thickness, of the side lip 6 is adjusted to a larger value, the side lip 6 is more likely to be warped when the centrifugal force acts on the tip end portion 41 of the side lip 6, and the tip end 41a of the tip end portion 41 of the side lip 6 becomes more likely to be moved away from the contact surface 33 of the sleeve 3.

The form factor of the side lip 6 is adjusted based on the above-described relationship between the form factor of the side lip 6 and the torque T to specify such a shape of a side lip 6 that the value of the unit torque (torque T/shaft-diameter D) of the hub seal 1 in the range of the practical rotation speed of the hub 52 becomes equal to or smaller than 3 N. The unit torque (torque T/shaft-diameter D) of the hub seal 1 may be a value in a partial range of a range equal to or smaller than 3 N in the range of the practical rotation speed of the hub 52.

Further, as described above, adjustment of a form factor of the upstream space S of the hub seal 1 for making the value of the muddy-water durable sliding distance in the range of the practical rotation speed of the hub 52 become equal to or longer than 3,000 km is performed. For example, the adjustment of the form factor such as the shape of the upstream space S of the hub seal 1 is performed such that in the range of the practical rotation speed of the hub 52, the foreign-body surface position is positioned at a position away, by a desired distance, from the seal surface A to the outer periphery side in the radial direction. The adjustment of the form factor of the upstream space S of the hub seal 1 is performed while foreign body shake-off performance of the hub seal 1 or a hub seal 5 is checked, for example.

A check on the foreign body shake-off performance can be performed by mounting the hub seal 1 or the hub seal 5 on the hub bearing 50, rotating the hub bearing 50 (relative rotation between the outer ring 51 and the hub 52), and checking the foreign-body surface position at each rotation speed. Further, the check on the foreign body shake-off performance may be performed by mounting the hub seal 1 or the hub seal 5 on a jig imitating the hub bearing 50. Further, a relationship between the foreign-body surface position and a rotation speed of the hub seal 1 or 5 or the rotation speed of the hub 52 is expressed by a mathematical expression, the foreign body shake-off performance of the hub seal 1 or 5 is calculated based on the mathematical expression, and the check on the foreign body shake-off performance may thereby be performed. Further, the check on the foreign body shake-off performance may be performed by a computer analysis and may be performed in a different method from the above-described method.

As described above, the form factor of the side lip 6 is adjusted such that the value of the unit torque (torque T/shaft-diameter D) of the hub seal 1 in the range of the practical rotation speed of the hub 52 becomes equal to or smaller than 3 N, and the side lip 4 is created in which the value of the unit torque (torque T/shaft-diameter D) of the hub seal 1 in the range of the practical rotation speed of the hub 52 becomes equal to or smaller than 3 N. The side lip 4 has a shape as in FIG. 2, for example, such that the value of the unit torque (torque T/shaft-diameter D) of the hub seal 1 in the range of the practical rotation speed of the hub 52 becomes equal to or smaller than 3 N.

Further, as described above, the form factor of the upstream space S of the hub seal 1 is adjusted such that even when the value of the unit torque (torque T/shaft-diameter D) of the hub seal 1 in the range of the practical rotation speed of the hub 52 is equal to or smaller than 3 N, the value of the muddy-water durable sliding distance in the range of the practical rotation speed of the hub 52 becomes equal to or longer than 3,000 km and the hub seal 1 has the needed seal performance, and the foreign body shake-off performance of the hub seal 1 is thereby adjusted. By the above adjustment, the upstream space S is created which has the foreign body shake-off performance in which even when the value of the unit torque (torque T/shaft-diameter D) of the hub seal 1 in the range of the practical rotation speed of the hub 52 is equal to or smaller than 3 N, the value of the muddy-water durable sliding distance in the range of the practical rotation speed of the hub 52 becomes equal to or longer than 3,000 km. The upstream space S, which has the foreign body shake-off performance in which even when the value of the unit torque (torque T/shaft-diameter D) of the hub seal 1 in the range of the practical rotation speed of the hub 52 is equal to or smaller than 3 N, the value of the muddy-water durable sliding distance in the range of the practical rotation speed of the hub 52 becomes equal to or longer than 3,000 km, has a shape as illustrated in FIG. 5, for example.

As described above, as for the hub seal 1, the value of the unit torque (torque T/shaft-diameter D) of the hub seal 1 in the range of the practical rotation speed of the hub 52 is equal to or smaller than 3 N, and the torque T is low. Further, the hub seal 1 has the foreign body shake-off performance in which even when the value of the unit torque (torque T/shaft-diameter D) of the hub seal 1 in the range of the practical rotation speed of the hub 52 is equal to or smaller than 3 N, the value of the muddy-water durable sliding distance in the range of the practical rotation speed of the hub 52 becomes equal to or longer than 3,000 km.

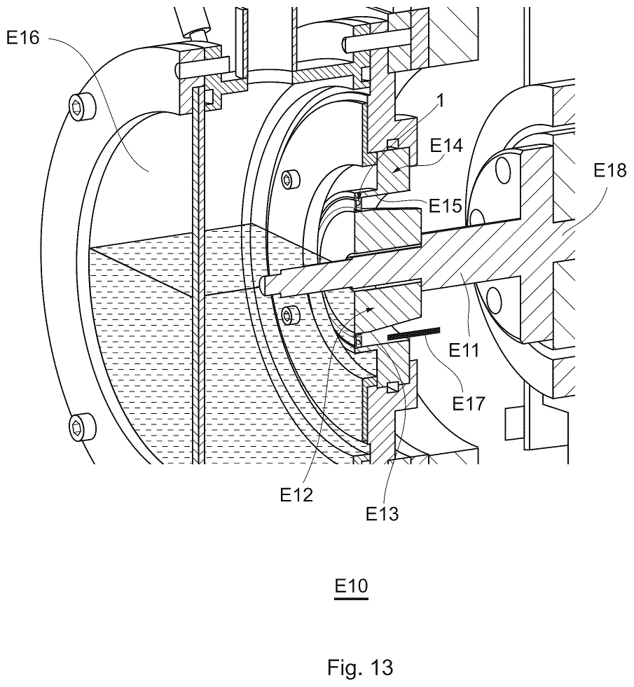

Measurement of the muddy-water durable sliding distance can be performed by using an evaluation device E10 illustrated in FIG. 13, for example. The evaluation device E10 has a rotating shaft E11 which is rotatable around an axis line, and a hub dummy body E12 is mounted on a tip end of the rotating shaft E11. In the usage state of the hub seal 1 which is illustrated in FIGS. 4 and 5, the hub dummy body E12 has a surface E13 having the same shape as the outer peripheral surface 54b of the end portion 54a of the inner ring 54 in which the reinforcement ring 10 of the seal main body 2 is press-fitted. Further, the evaluation device E10 has an outer ring dummy body E14, and the outer ring dummy body E14 has a fixing portion E15 as a portion having the same shape as the end portion 51a of the outer ring 51 in which the sleeve 3 is press-fitted in the usage state of the hub seal 1 which is illustrated in FIG. 4. The hub seal 1 is mounted between the outer ring dummy body E14 and the hub dummy body E12. Specifically, the sleeve 3 is press-fitted in the fixing portion E15 of the outer ring dummy body E14, the reinforcement ring 10 of the seal main body 2 is press-fitted in the surface E13 of the hub dummy body 12, and the contact surface 4a of the side lip 4 contacts the contact surface 33 of a circular ring portion 32 of the sleeve 3 in the predetermined interference. In this case, similarly to the usage state of the hub seal 1 which is illustrated in FIGS. 4 and 5, the contact surface 4a of the side lip 4 contacts the contact surface 33 of the circular ring portion 32 of the sleeve 3. Accordingly, an internal portion of the evaluation device E10 is sealed. In the evaluation device E10, a sealing head E16 which forms a sealed space storing muddy water is formed on an outside of the outer ring dummy body E14 and the hub dummy body E12, and muddy water is enclosed in the sealing head E16. Further, on an inner peripheral surface of the outer ring dummy body E14, a water leakage sensor E17 is mounted in a position in the vicinity of the hub seal 1. In a case where muddy water leaks out to the internal portion side beyond the hub seal 1, the water leakage sensor E17 detects the leaking muddy water. Note that the muddy water leaking out beyond the hub seal 1 is accumulated in a position in the vicinity of the hub seal 1 on a portion on a lower side of the inner peripheral surface of the outer ring dummy body E14. Further, torque of the rotating shaft E11 is detected by using a torque measurement apparatus E18. For example, the torque measurement apparatus E18 detects the torque of the rotating shaft E11 in a predetermined cycle.

The evaluation device E10 is capable of measuring a distance for which the contact surface 4a of the side lip 4 slides with respect to the contact surface 33 of the slinger 3. For example, a sliding distance of the contact surface 4a of the side lip 4 in a case where the hub dummy body E12 performs one rotation is a circumference of the contact surface 4a. The muddy-water durable sliding distance is a distance for which the contact surface 4a of the side lip 4 slides with respect to the contact surface 33 of the slinger 3 until the muddy water leaks out to the internal portion side beyond the hub seal 1. In other words, in the evaluation device E10, the distance, for which the contact surface 4a of the side lip 4 slides with respect to the contact surface 33 of the slinger 3 until the water leakage sensor E17 detects leakage of the muddy water after a start of measurement of the muddy-water durable sliding distance, is the muddy-water durable sliding distance. In the evaluation device E10, the torque T of the hub seal 1, which is detected by the torque measurement apparatus E18 when the rotating shaft E11 is rotated in the range of the practical rotation speed of the hub 52, is a value at which the unit torque (torque T/shaft-diameter D) of the hub seal 1 becomes equal to or smaller than 3 N. Further, in the evaluation device E10, in a case where the rotating shaft Ell is rotated in the range of the practical rotation speed of the hub 52, the muddy-water durable sliding distance of the hub seal 1 is equal to or longer than 3,000 km.

In such a manner, the hub seal 1 can lower a limit, for maintaining the needed seal performance, to reduction in the lip reaction force F of the side lip 4. Thus, the hub seal 1 can lower a limit, for maintaining the needed seal performance, to reduction in the torque of the hub seal 1.

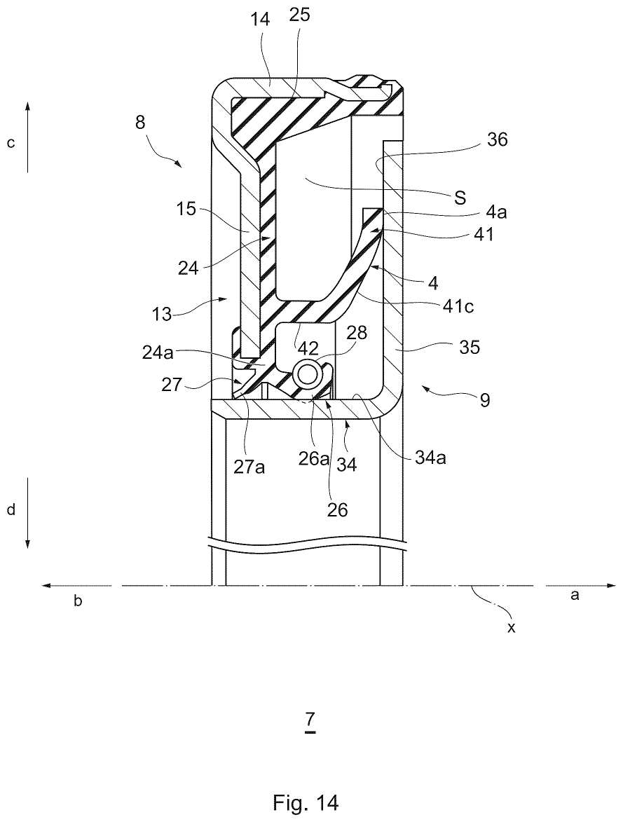

Next, a hub seal 7 according to a second embodiment of the present disclosure will be described. FIG. 14 is a cross-sectional view in a cross section, along the axis line x, of the hub seal 7 according to the second embodiment of the present disclosure. Note that the cross section of the hub seal 7 on one side with respect to the axis line x is illustrated in FIG. 14. Further, in FIG. 14, the hub seal 7 is illustrated in a usage state. A hub seal according to the present disclosure is not limited to a hub seal to be applied to a hub bearing of the inner ring rotation type like the above-described hub seal 1 and includes hub seals to be applied to hub bearings of an outer ring rotation type. The hub seal 7 is a hub seal to be applied to a hub bearing of the outer ring rotation type. Hereinafter, as for the hub seal 7, the same reference characters as the reference characters for the hub seal 1 are given to configurations having functions the same as or similar to those of the above-described hub seal 1, descriptions thereof will not be made, and different configurations from those of the hub seal 1 will be described.

As illustrated in FIG. 14, the hub seal 7 has the side lip 4 similarly to the hub seal 1. Further, in the hub seal 7, a value of the unit torque (torque T/shaft-diameter D) in the hub bearing which rotates at a rotation speed in a predetermined range is equal to or lower than 3 N, and a value of the muddy-water durable sliding distance is equal to or longer than 3,000 km.

As illustrated in FIG. 14, for example, the hub seal 7 specifically includes a seal main body 8 as a first seal member to be mounted on an outer ring (not illustrated) of the hub bearing (not illustrated) on a rotating side and a sleeve 9 as a second seal member to be mounted on an inner ring (not illustrated) of the hub bearing on a fixed side. Each of the seal main body 8 and the sleeve 9 is a member which is annular around the axis line x, and the seal main body 8 has the side lip 4 which is annular around the axis line x. The seal main body 8 is fixed to the outer periphery side differently from the above-described seal main body 2, and the sleeve 9 is fixed to the inner periphery side differently from the above-described sleeve 3.

The sleeve 9 has a cross-sectional shape similar to that of the sleeve 3 and has a tubular portion 34 corresponding to the tubular portion 31 of the sleeve 3 and a circular ring portion 35 corresponding to the circular ring portion 32 of the sleeve 3. The tubular portion 34 has such a shape that the tubular portion 34 is fitted in the inner ring in the interference fit manner so that the sleeve 9 is fitted on the inner ring. In the circular ring portion 35, a contact surface 36 as a surface that the side lip 4 contacts in the usage state of the hub seal 7 is formed. The contact surface 36 is a surface in the circular ring portion 35, which faces the inner side, and is a flat surface or a generally flat surface which expands in parallel or generally parallel with a flat surface orthogonal or generally orthogonal to the axis line x and is annular around the axis line x.

The seal main body 8 has a reinforcement ring 13 corresponding to the reinforcement ring 10 of the seal main body 2 and an elastic body portion 23 corresponding to the elastic body portion 20 of the seal main body 2. The reinforcement ring 13 has a cross-sectional shape similar to that of the reinforcement ring 10 and has a tubular portion 14 corresponding to the tubular portion 11 of the reinforcement ring 10 and a circular ring portion 15 corresponding to the circular ring portion 12 of the reinforcement ring 10. The tubular portion 14 has such a shape that the outer ring is fitted in the tubular portion 14 in the interference fit manner so that the reinforcement ring 13 is fitted on the outer ring.

The elastic body portion 23 has a base body portion 24 and a tubular-shaped portion 25 which respectively correspond to the base body portion 21 and the tubular-shaped portion 22 of the elastic body portion 20 of the seal main body 2. The base body portion 24 is a portion which is mounted on a portion, on the inner periphery side, of the circular ring portion 15 of the reinforcement ring 13, and the tubular-shaped portion 25 is a portion which is mounted on a portion, on the outer periphery side, of the circular ring portion 15 of the reinforcement ring 13 and on the tubular portion 14. Further, the elastic body portion 23 has a seal lip 26 and a grease lip 27. The side lip 26 is intended to prevent entry of foreign bodies into the sealed space S1 and is intended to prevent outflow of the lubricant from the inside of the sealed space S1. Further, the grease lip 27 is intended to prevent outflow of the lubricant from the inside of the sealed space S1. Note that the hub seal 7 does not have to have the side lip 26. Similarly, the hub seal 7 does not have to have the grease lip 27.

The seal lip 26 extends to the outer side from an end portion (inner periphery end portion 24a) of the base body portion 24 on the inner periphery side, the end portion being positioned in the vicinity of an end portion, on the inner periphery side, of the circular ring portion 15 of the reinforcement ring 13, and the grease lip 27 extends from the inner periphery end portion 24a of the base body portion 24 to the inner side and the inner periphery side. The seal lip 26 has a form similar to that of a known seal lip and has a lip tip end portion 26a on a tip end side as illustrated in FIG. 14. The lip tip end portion 26a is a portion whose cross section has a wedge shape, for example, and contacts an outer peripheral surface 34a of the tubular portion 34 of the sleeve 8 in the usage state. The grease lip 27 has a form similar to that of a known grease lip, and a lip tip end portion 27a contacts the outer peripheral surface 34a of the tubular portion 34 of the sleeve 8 in the usage state as illustrated in FIG. 14. Further, in the seal lip 26, a garter spring 28 is mounted in a position on an opposite side to the lip tip end portion 26a, and the garter spring 28 exerts tightening force on the seal lip 26 to push the lip tip end portion 26a to the inner periphery side and enhances tightening force to press the lip tip end portion 26a onto the tubular portion 34 of the sleeve 9.

Further, as described above, the elastic body portion 23 has the side lip 4. As illustrated in FIG. 14, in the hub seal 7, the side lip 4 extends from the base body portion 24 of the elastic body portion 23 toward the outer side and the outer periphery side, the inner peripheral surface 41c of the side lip 4 forms the contact surface 4a for sealing of a space between the outer ring and the inner ring. Further, in the usage state of the hub seal 7, the side lip 4 is formed such that the contact surface 4a of the tip end portion 41 contacts the contact surface 36 of the sleeve 8 while having a predetermined interference.

In the hub seal 7, similarly to the hub seal 1, the side lip 4 has such a form that the value of the unit torque (torque T/shaft-diameter D) becomes equal to or smaller than 3 N, and the upstream space S has such a form that the muddy-water durable sliding distance becomes equal to or longer than 3,000 km.

In such a manner, the value of the unit torque (torque T/shaft-diameter D) of the hub seal 7 is equal to or smaller than 3 N, and the value of the muddy-water durable sliding distance of the hub seal 7 is equal to or longer than 3,000 km. Specifically, for example, the hub seal 7 is provided such that the value of the unit torque (torque T/shaft-diameter D) of the hub seal 7 in a range of a practical rotation speed of the hub bearing as the mounting target becomes equal to or smaller than 3 N and such that the muddy-water durable sliding distance in the range of the practical rotation speed of the hub bearing as the mounting target becomes equal to or longer than 3,000 km. The hub seal 7 acts similarly to the above-described hub seal 1, can lower the torque T, and has the foreign body shake-off performance in which even when the value of the unit torque (torque T/shaft-diameter D) of the hub seal 7 in the range of the practical rotation speed of the hub bearing is equal to or smaller than 3 N, the value of the muddy-water durable sliding distance in the range of the practical rotation speed of the hub bearing becomes equal to or longer than 3,000 km.

In such a manner, the hub seal 7 can lower the limit, for maintaining the needed seal performance, to reduction in the lip reaction force F of the side lip 4.

Further, the seal lip 26 and the grease lip 27 are provided in the hub seal 7, entry of foreign bodies can be prevented by the seal lip 26 and the grease lip 27 in addition to the side lip 4, and outflow of the lubricant can be prevented. Further, because the garter spring 28 is mounted on the seal lip 26, in the seal lip 26, the tightening force onto the tubular portion 34 of the sleeve 9 is enhanced by the garter spring 28. Thus, the seal lip 26 is inhibited from moving away from the tubular portion 34 of the sleeve 9 during rotation, particularly, high-speed rotation of the hub bearing, and outflow of the lubricant can be inhibited. In such a manner, in the hub seal 7, the lubricant is much less likely to flow out.

In the foregoing, the embodiments of the present disclosure have been described. However, the present disclosure is not limited to the hub seals 1 and 7 according to the above-described embodiments of the present disclosure and includes all forms which are included in the concepts and the claims of the present disclosure. Further, configurations may appropriately selectively be combined such that at least a part of the above-described objects and effects is exhibited. For example, shapes, materials, arrangement, sizes, and so forth of the configurations in the above-described embodiments can appropriately be changed in accordance with specific usage forms of the present disclosure.

For example, the hub seals 1 and 7 have the sleeves 3 and 9 as individual members, but each of the sleeves 3 and 9 may integrally be formed with the hub bearing 50. For example, the contact surface 33 of the sleeve 3 may be formed in the end portion 51a of the outer ring 51 of the hub bearing 50.

For example, a hub seal according to the present disclosure can be applied to an in-wheel motor unit. An in-wheel motor unit is a driving device in which a hub bearing and a motor are integrally configured, is mounted on a wheel of a vehicle, gives motive power to the wheel by supplying a motor output to the wheel via the hub bearing, and generates electricity by converting the motive power of the wheel into electric power via a motor generator.

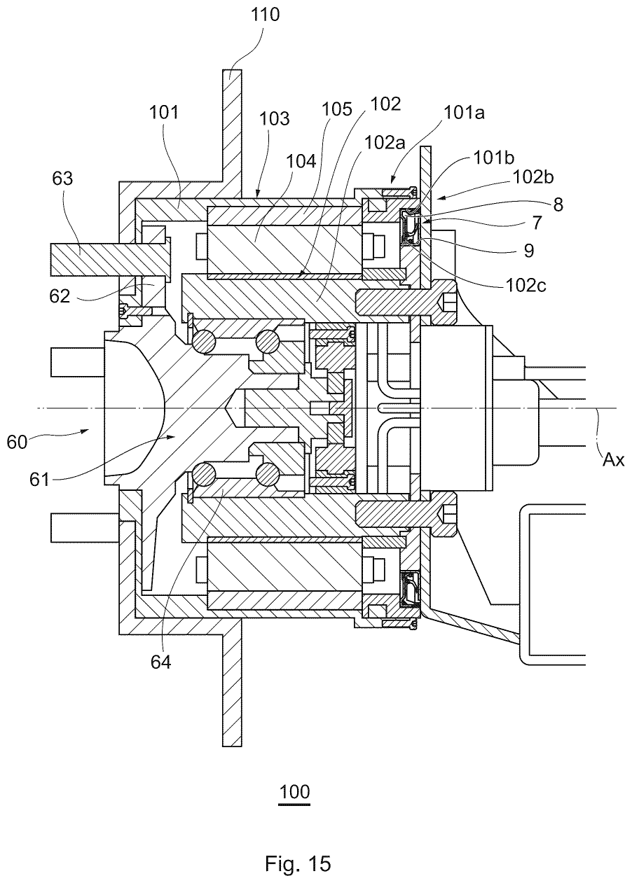

FIG. 15 is a cross-sectional view of one example of an in-wheel motor unit for which the hub seal 7 according to the second embodiment of the present disclosure is used. For example, as illustrated in FIG. 15, an in-wheel motor unit 100 includes a hub bearing 60 of the inner ring rotation type, an outside casing 101 as an outside member which is mounted on the hub bearing 60, an inside casing 102 as an inside member, and a motor generator 103. Specifically, the outside casing 101 is a member which is tubular and forms an inside space housing the hub bearing 60. The outside casing 101 is held between a hub flange 62 included in an inner ring 61 of the hub bearing 60 and a brake disk 110 to be mounted on the hub flange 62 and is fixed between the hub flange 62 and the brake disk 110 by fixing the wheel to the inner ring 61 by a hub bolt 63.

The inside casing 102 has a tubular portion 102a as a member which is tubular and forms a space, on the inner periphery side, which houses an outer ring 64 of the hub bearing 60 and a disk portion 102b as a portion which has a disk shape and expands from an end portion of the tubular portion 102a on the inner side to the outer periphery side. The tubular portion 102a has such a shape that the outer ring 64 is fitted in and fixed to the space on the inner periphery side. As illustrated in FIG. 15, the outside casing 101 and the inside casing 102 have shapes in which a surface of the outside casing 101 on the inner periphery side and a surface, on the outer periphery side, of the tubular portion 102a of the inside casing 102 are opposed to each other and an annular space is formed between the outside casing 101 and the tubular portion 102a. Further, as illustrated in FIG. 15, the outside casing 101 and the inside casing 102 have shapes in which an end portion (end portion 101a) of the outside casing 101 on the inner side is opposed to the disk portion 102b of the inside casing 102 in an axis line Ax direction. An annular gap is formed between the end portion 101a of the outside casing 101 and the disk portion 102b.

The motor generator 103 is a member which is tubular and extends along the axis line Ax and is provided in the annular space between the outside casing 101 and the tubular portion 102a of the inside casing 102. Specifically, the motor generator 103 includes a rotor 104 and a stator 105, the rotor 104 is fixed to the outside casing 101, and the stator 105 is fixed to the tubular portion 102a of the inside casing 102.

In the in-wheel motor unit 100, the hub seal 7 is provided to prevent foreign bodies from entering an internal portion of the in-wheel motor unit 100 through the annular gap between the end portion 101a of the outside casing 101 and the disk portion 102b of the inside casing 102. For example, as illustrated in FIG. 15, the hub seal 7 is mounted between the end portion 101a of the outside casing 101 and the disk portion 102b of the inside casing 102. Specifically, the sleeve 9 is fitted on a mounting surface 102c of the disk portion 102b of the inside casing 102 in the interference fit manner, and the sleeve 9 is fixed to the disk portion 102b of the inside casing 102. Further, specifically, the seal main body 8 is fitted on a mounting surface 101b of the end portion 101a of the outside casing 101 in the interference fit manner, and the seal main body 8 is fixed to the outside casing 101. Note that the mounting surface 102c of the disk portion 102b of the inside casing 102 is a surface which has a cylindrical surface shape and extends along the axis line Ax, and the mounting surface 101b of the end portion 101a of the outside casing 101 is a surface which has a cylindrical surface shape and extends along the axis line Ax. Further, the mounting surface 101b and the mounting surface 102c are opposed to each other in the radial direction.

1. A hub seal having a side lip and being intended for sealing of a space between an outer ring and a hub of a hub bearing, the hub seal being characterized in that
a value (torque T/shaft-diameter D) resulting from division of torque T as a value of torque of the hub seal in the hub bearing, which rotates at a rotation speed in a predetermined range, by a shaft diameter D as a value of a diameter of a shaft of the hub bearing is equal to or lower than 3 N,
a value of a muddy-water durable sliding distance is equal to or longer than 3,000 km, and
the muddy-water durable sliding distance is a distance for which the side lip slides until a foreign body oozes out to a sealing target object side.

2. The hub seal according to claim 1, characterized in that
the side lip has such a shape that the torque T in a case where the hub bearing rotates at a rotation speed in a predetermined range becomes smaller than the torque T in a case where the hub bearing rotates at a lower rotation speed than the rotation speed in the predetermined range, and
a magnitude of the torque T made smaller is set based on a position to which a foreign body entering an internal portion of the hub seal is moved to an outer periphery side by rotation of the hub bearing.

3. The hub seal according to claim 1, characterized in that
the side lip rotates together with one of the outer ring and the hub, which rotates, and a surface facing an inner periphery side becomes a contact surface for the sealing.

4. The hub seal according to claim 3, further comprising
a sleeve as an annular member, characterized in that
the sleeve is fixed to one of the outer ring and the hub, which does not rotate, and
the contact surface of the side lip contacts the sleeve for the sealing.

5. The hub seal according to claim 1, characterized in that
the torque of the hub seal is torque which is necessary for rotating the hub seal against sliding resistance of the side lip based on lip reaction force as a value of reaction force of the side lip.

6. The hub seal according to claim 1, characterized in that
one of the outer ring and the hub, which rotates, has the shaft of the hub bearing.
